(19) United States
(12) Patent Application Publication
(10) Pub. No.: US 2005/0108727 A1
(43) Pub. Date: May 19, 2005

(54) Application binding in a network environment

(75) Inventors: David R. Bernstein, Scotts Valley, CA (US); Robert W. Otis, San Jose, CA (US); Rodrigo A. Laguisma, Cupertino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: FINISAR CORPORATION

(21) Appl. No.: 10/965,333

(22) Filed: Oct. 14, 2004

Related U.S. Application Data
(63) Continuation-in-part of application No. 10/940,387, filed on Sep. 13, 2004.
(60) Provisional application No. 60/502,018, filed on Sep. 11, 2003.

(51) Int. Cl. G06F 9/46; G06F 9/44

(52) U.S. Cl. 719/320; 719/331

(57) ABSTRACT

A system of and method for completing one or more parameters or network interface configurations in a task executed by an application program are disclosed. The system and method have particular application with application programs associated with network analyzers and similar network analysis tools for use in monitoring and diagnosing problem conditions in communications and storage networks. In accordance with one embodiment of the method, a task module is loaded into system memory of a computer system. Parameters or network interface configurations associated with the task module that are to be completed are identified. A resolution plan to complete each parameter or network interface configuration is created. The resolution plan is then executed in connection with assisting modules to complete for each parameter or network interface configuration. The completed parameters or network interface configurations are then input into the task module and the task module is executed.

### CROSS-REFERENCE TO RELATED APPLICATIONS

This application is a continuation-in-part of U.S. patent application Ser. No. 10/940,387, entitled “METHOD OF GRAPHICALLY DISPLAYING AND MANIPULATING MULTIPLE WORKFLOW RUN INSTANCES OF A SOFTWARE APPLICATION,” filed Sep. 13, 2004, which claims the benefit of U.S. Provisional Patent Application No. 60/502,018, filed Sep. 11, 2003, entitled “RUNTIME BINDING OF APPLICATION TO NETWORK.” Each of these applications is incorporated herein by reference in its entirety.

### BACKGROUND

1. Technology Field

The present invention generally relates to computer systems. More particularly, the present invention relates to systems for and methods of automatically configuring and setting parameters to be used by a task module that is executed in a computer system.

2. The Related Technology

Modern computer networks involve the transmission of large amounts of data at very high speeds across the networks. For example, in some networks, transmission rates as high as 10 Gbits/second are currently being used. Today, hardware and protocols that will support transmission rates up to 40 Gbits/second are being developed. Within these networks, transmission problems may occur intermittently.

Using network analysis tools, network administrators can identify and resolve various types of network problems. In some situations, network problems may be resolved by sampling a portion of the data transmitted across the network or by performing a statistical analysis on portions of the transmitted data. Other solutions require the collection of all data that traverses the network during a given time period, or the execution of various tasks intended to diagnose and/or resolve problem conditions in the network.

One example of a network analysis tool mentioned above is a network analyzer. Network analyzers utilize a combination of hardware and software components to monitor data transmitted across the network, to capture such data upon the execution of one or more triggers, and to analyze captured data in order to diagnose or detect problem conditions existing on the network. As such, the software applications that cooperate with hardware components of the network analyzer are critical to ensure proper data traffic monitoring, capture, and problem condition diagnosis. Indeed, software applications used in this manner can be employed to view and/or manipulate various network configurations and overall topology of the physical network. Thus, these software applications are highly beneficial in maximizing the utility of network analyzers and other types of network analysis tools.

Software applications, such as those employed in connection with a network analyzer, are typically configured to execute one or more of a plurality of tasks in connection with their intended operation. With respect to a network analyzer, the software application engages in a variety of network-related tasks including data packet generation, trace control, data filtering and triggering, network performance, monitoring, alarming, data capture to disk, packet blasting, jamming, congestion analysis, statistics-based monitoring, etc.

To ensure proper execution, each task performed by the software application typically includes one or more parameters that are defined before or during task execution. Parameters include variables, options, identifying and securing data processing file location, etc. Such parameters must be correctly identified and resolved by the task before task execution.

With respect to communications networks, the tasks of a network-related software application can further include, in addition to or instead of parameters, various network interface configurations that must be defined for proper task execution. Such network interface configurations are necessary to ensure proper interfacing between the application, the network analyzer, and the communications network itself. For example, if a particular software application is to be employed in a network analyzer to monitor a portion of a communications network, considerable effort is typically required of a user to not only set up the software application and its associated tasks, but also to properly configure the interface of the application with the relevant portion of the communications network in order to ensure proper task execution. In another example, the configuring of network interfaces can further include identifying and securing network-based storage resources. In this context the configuring of network interfaces may include software configuration as well as the physical arrangement of network cables, taps, splitters, and other physical network elements.

Collectively, the process of setting, or completing, parameters and of configuring network interfaces is commonly known as “binding” the application to the network. If performed manually, i.e., solely by the efforts of a user, the binding process can involve a significant time investment by the user before the task can be satisfactorily executed.

Because of its relative difficulty, manual binding is typically practiced only by those users who are intimately familiar with communications networks. With the explosive growth of information technology sectors, however, an increasing number of users of network analysis tools, such as a network analyzer, lacks the requisite network experience to properly complete the manual binding process, notwithstanding the need for these less experienced users to employ such applications. As a result, network-related tasks that can be of benefit to the user in monitoring and diagnosing network conditions are either performed at great expense of the user, or are not performed at all, given the lack of requisite knowledge required possessed by the user.

Significantly, the above problems related to manual binding are not limited to communications network-related software applications. Indeed, such challenges exist in software applications that are employed in a variety of contexts and environments.

In light of the above, a need therefore exists by which software applications can be successfully and readily implemented to execute various tasks without engaging in the manual binding procedures described above. In particular, a need exists for a method by which one or more parameters associated with a task to be executed by a software application, and a method by which one or more configurations of network interface associated with a task to be executed by a software application, can be automatically identified and completed without extensive input by a user of the application. Any solution should enable task parameter completion and network interface configuration for applications that operate in connection with communications networks and related hardware, such as network analyzers.

### BRIEF SUMMARY

Briefly summarized, embodiments of the present invention are directed to a system and method by which various parameters and/or network interface configurations of one or more tasks to be executed by a software application are automatically identified and completed without significant intervention by a user. The software application can be employed in connection with a variety of hardware and software configurations, but in one embodiment the application is employed in connection with a network analysis tool, such as a network analyzer, for monitoring and analyzing communications networks.

In brief, embodiments of the present invention enable a user to select or create a task to be executed by the software application. Once the task is selected, the present method is employed to identify the number and nature of any parameters and network interface configurations that must be identified and completed before execution of the task can proceed. Each identified parameter and/or network interface configuration is then completed by assigning it a value or characteristic in accordance with the purpose of the task, thereby enabling the task to be executed by the software application. This method is automatically accomplished in one embodiment without the need for significant intervention by the user, i.e., manual binding, in configuring the task to run.

In one embodiment, then, a method is disclosed for preparing a task module for execution by a computer system having a system memory. The method comprises loading the task module into the system memory, then identifying a parameter/network interface configuration of the task module to be completed. The method further includes determining a sequence for completing each of the task parameters/network interface configuration and inputting the completion sequence into a resolution strategy executable. The resolution strategy executable is executed to complete the parameter/network interface configuration, and the parameter/network interface configuration is input into the task module. The complete task module is then executed.

In another embodiment, a computer system is disclosed that comprises a system memory, and a plurality of task modules that each include one or more uncompleted parameters or network interface configurations, as well as computer executable instructions for performing a method for completing the parameters or network interface configurations. The method comprises using a task binding data structure included in the task module to determine a completion sequence to complete the parameters and/or network interface configurations, inputting the completion sequence into a resolution strategy executable and executing the executable to complete the parameter or network interface configuration, then inputting the completed parameter or network interface configuration into the task module, and executing the task module.

In yet another embodiment, a computer program product for implementing a method of preparing a task module for execution in a computer system having a system memory is disclosed. The computer program product includes a computer readable medium that carries computer executable instructions for performing the method, wherein the method comprises loading the task module into the system memory, and determining a plurality of parameters or network interface configurations of the task module to be completed. The method further includes determining a completion sequence to order the completion of each of the parameters or network interface configurations, executing a resolution strategy executable to complete each of the parameters or network interface configurations, inputting the completed parameters or network interface configurations into the task module, and executing the task module.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram showing various details of one environment in which embodiments of the present invention can be practiced;

FIG. 2 is a block diagram showing various data structures that are included in a task module of the environment shown in FIG. 1;

FIG. 3 is a block diagram showing various stages of a method according to one embodiment of the present invention; and

FIG. 4 is a simplified diagram showing various portions of a communications network including a virtual network topology for use in connection with one embodiment of the present invention.

### DETAILED DESCRIPTION OF SELECTED EMBODIMENTS

Reference will now be made to figures wherein like structures will be provided with like reference designations. It is understood that the drawings are diagrammatic and schematic representations of exemplary embodiments of the invention, and are not limiting of the present invention nor are they necessarily drawn to scale.

FIGS. 1-4 depict various features of embodiments of the present invention, which is generally directed to a system and method that enables and automates the parameterization and configuration of software applications that are executed by a computer system. In one embodiment, such automation is referred to as automatic binding of a software application to one or more task parameters and/or network interface configurations of a communications network. The method as disclosed herein eliminates manual binding that must be done by a user, such as a network administrator, when a task to be initiated by a software application is desired to be executed. The automatic binding presented herein enables a user to more easily take advantage of aspects and features of the software application and any hardware that implements the software, such as a network analyzer for monitoring a communications network.

In one embodiment, the systems and methods of the present invention are employed in connection with a software application that is associated with or comprises a part of a network analyzer for monitoring data transmissions within a communications network. As such, embodiments of the present invention are able to automatically bind tasks of a software application with respect to various network-related parameters and interface configurations that must be identified and completed for the task to properly execute. In one particular embodiment, such as when interface configurations of the task involve one or more logical connections to a portion of the communications network, embodiments of the present invention facilitate automatic binding between the task and the network components, thereby enabling task execution with minimum user effort in configuring the application.

Reference is first made to FIG. 1, which depicts an exemplary operating environment, generally depicted at 100, in which embodiments of the present invention can be practiced. In detail, the environment 100 includes a computer system 110 that is in communication with a communications network (not shown). The communications network can include, but is not limited to, Local Area Networks, Wide Area Networks, Storage Area Networks, the Internet and the like or any other combination thereof. The communications network can be either a wired and/or wireless network.

In one embodiment, the computer system 110 is a network analyzer or similar apparatus for monitoring network data traffic in the communications network in order to detect and diagnose problem conditions existing in the network, such as problem conditions existing between network components, or links between components.

The computer system 110 includes an application program 130 including computer executable instructions that are included in one or more modules. In detail, application program 130 and its various modules can be located in one or more portions of the computer system 110, including a system memory 140 and storage 150. In the illustrated embodiment, the system memory 140 includes a task binding runner module 160, while the storage 150 includes scripts, wizards, and solvers 170. However, the task binding runner module 160 can also be stored in storage 150 when not in use, and the scripts, wizards, and solvers 170 can be included in the system memory 140 when needed during task execution. As such, the depictions of the various components shown in FIG. 1 is not meant to be limiting in any way. These components are employed in connection with practice of the present invention, as will be further described below.

The storage 150 further includes a plurality of task modules 200, wherein each task module contains computer executable instructions for performing one or more tasks. As shown in FIG. 1, the system memory 140 includes amongst other things, a selected task module 200A that is chosen from the plurality, or library, of task modules 200 found in the storage 150. In general, when the application program 130 is prepared to execute a particular task, the task module 200 that pertains to the desired task can be called up from the storage 150 and included in the system memory 140 of the computer system 110 for execution, identified in FIG. 1 as a “Current Task Context.” Further details regarding this process are found further below.

The task modules 200 can be found in various states of binding, i.e., various states of parameter/network interface configuration completeness. This may be due to several factors, including the fact that one or more modules are newly loaded into the application program, and hence have not yet been bound, or that one or more modules have not yet been fully executed by the application program, and hence may not yet be fully bound, or that a module has been previously executed and is fully bound as a result.

In addition to the components shown in FIG. 1, other modules containing computer executable instructions can be contained within the application program 130. Indeed, it is appreciated that additional or other modules and/or components alternatively can be included in the application program 130 and/or computer system 110 to accomplish tasks similar or in addition to those to be described herein. Also, though described herein as a network analyzer, the computer system 110 can include any one of a variety of computer systems, including specific or general purpose computers designed according to a particular need. In addition, though discussed here as cooperating with a communications network, embodiments of the present invention can be employed independent of any communications network. Thus, stand alone and other computer system configurations can also benefit from the principles of the present invention as described herein. Therefore, the description of the various embodiments of the present invention as described herein should not be construed as limiting the present invention in any way.

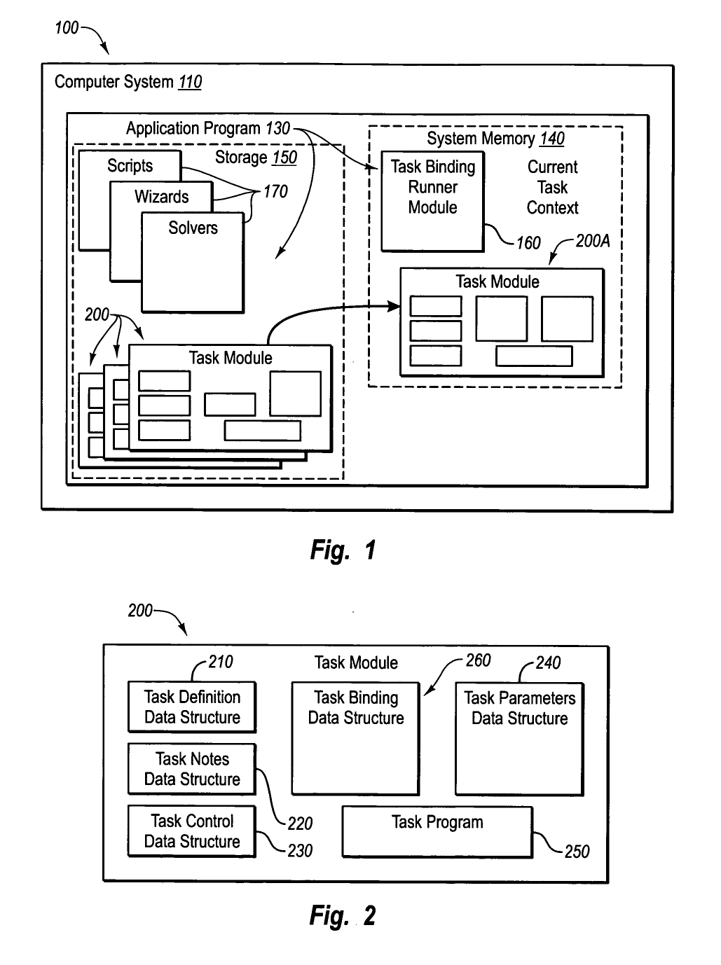

Reference is now made to FIG. 2, which depicts various details of an exemplary one of the task modules 200 shown in FIG. 1. As shown, the task module 200 includes various data structures, including a task definition data structure 210, a task notes data structure 220, a task control data structure 230, a task parameter data structure 240, a task program 250, and a task binding data structure generally shown at 260. Each of the data structures identified in FIG. 2 contain computer executable instructions for defining a particular portion of or performing a specified operation of the task for which the particular task module 200 is responsible. Thus, as shown in FIG. 1 the application program 130 can include multiple task modules 200, wherein each task module is responsible for executing a particular task of the application program. In this way, the functionality of the application program 130 as a whole can be achieved via execution of one or more of tasks embodied in the various task modules 200.

In greater detail regarding one embodiment, the task definition data structure 210 is configured to convey programmatic details of the task, including input and output interfaces used during task execution, task version data, etc. The task notes data structure 220 contains textual descriptions of the task and its purposes, embedded text for use in on-line help displays, on-line documentation, and version control/modification history annotations. The task control data structure 230 contains definitions on the run time characteristics of the task represented by the task module 200. In particular, the task control data structure 230 controls contingencies such as whether the task is to continue running when the application program 130 is terminated, procedures for pausing and restarting the task module 200, procedures for acquiring run time reporting and task progress status, and other system management functions.

The task parameters data structure 240 contains storage space for each parameter and/or each network interface configuration used by the task represented by the task module 200, as well as any accompanying data. Thus, for each task parameter or network interface configuration, corresponding definition space is included in the task parameter data structure 240 for receipt and storage of such parameter/network interface configuration information. The task program 250 contains the computer executable instructions to perform the task itself, such as code, meta-code, workflow, script, rule, etc. in cooperation with the other data structures described herein.

In accordance with one embodiment, the task binding data structure 260 is configured to coordinate the automatic identification and completing of each of the one or more parameters and/or network interface configurations that are required by a specified task represented by one of the task modules 200 for execution by the application program 130. As mentioned, the task program 250 contains computer executable instructions for performing the task represented by the task module 200. As such, these instructions often require a set of parameters and/or network interface configurations to be supplied to the task program 250 to enable execution thereof.

The parameters can include many forms of data including, but not limited to, variables, constants, and options, output sources, processing and storage resources, firmware, files, among many others. Similarly, the network interface configurations can include many forms of data including, but not limited to, network topology, protocol data, network port numbers and addresses, various permissions, and tokens, etc. which the task and/or application program 130 are to utilize and connect with during task execution.

Note that a task module can include one or a plurality of parameters or network interface configurations. Further, each task module can include only parameters, only network interface configurations, or a combination of both.

The task binding data structure 260 contains code, meta-code, dialogs, wizards, and other sets of executable instructions or meta-instructions to enable it to investigate, identify, and configure the various parameters needed by the task program 250 in order to enable task execution. As used herein, when a sufficient value or designation is assigned to a parameter or a network interface configuration as may be required for a task, the parameter or network interface configuration is considered “completed.” Significantly, this process is performed with little or no intervention by a user (not shown), thereby facilitating an increased level of program automation.

As a prophetic example, in one case, a task contained within the application program 130 may require the computer system 110 to establish a logical connection with multiple connection points, or nodes, within a communications network, such as an enterprise topology. In order to establish such connections with the nodes, various network interface configurations may need to be defined, such as MAC addresses, IP addresses, and ports of various components within the network. In addition, task behaviors such as timing or filters may need to be specified via one or task parameters. Further, various network monitoring components may also need to be identified having locations within the network that enable appropriate connections with the computer system 110 to be made. Thus, the task involves various parameters and network interface configurations that, when completed, ensure that the proper network and monitoring equipment having the proper configurations and network locations is present to enable the necessary pathways between the computer system 110 and the network nodes to be established. Such parameters and network interface configurations, which are stored in the task parameter data structure 240 of the respective task module 200, can have default definitions stored in the application program 130 or task module. The parameters and network interface configurations can also be user-defined via a graphical user interface, or can be composed of a combination of both default and user-defined data. Note that, should some of the parameters and network interface configurations of the task module fail to be properly identified and/or completed, the task may not properly execute.

In one embodiment, the task binding data structure 260 is responsible for identifying and completing the various parameters/network interface configurations that are contained within a specified task of a task module, such as the selected task module 200A in FIG. 1 and the module 200 shown in FIG. 2. As such, the task binding data structure 260 is configured to execute a plurality of operations that are directed toward completing each of the parameters and network interface configurations needed for the task to run. These operations include the identification of any needed parameters, determining any temporal ordering and/or dependency between the various parameters to be completed, the mapping and association of a parameter or network interface configuration and its name to a specified resolution module that is used to solve to completeness for the given parameter or network interface configuration, the creation of a resolution strategy executable operation, and governance of the various resolution modules. When this process for completing the parameters and network interface configurations of a specified task is followed to completeness, that is, there is sufficient specificity in the value or definition of each parameter/network interface configuration to enable network connection and execution of the task on a specified communications network segment, the process is referred to herein as “binding.” To the extent that the completion process is performed in whole or in part without user intervention, binding is further referred to herein as “automatic binding.” Further details regarding the above responsibilities of the task binding data structure 260, as well as details regarding parameter resolution procedures, are given further below.

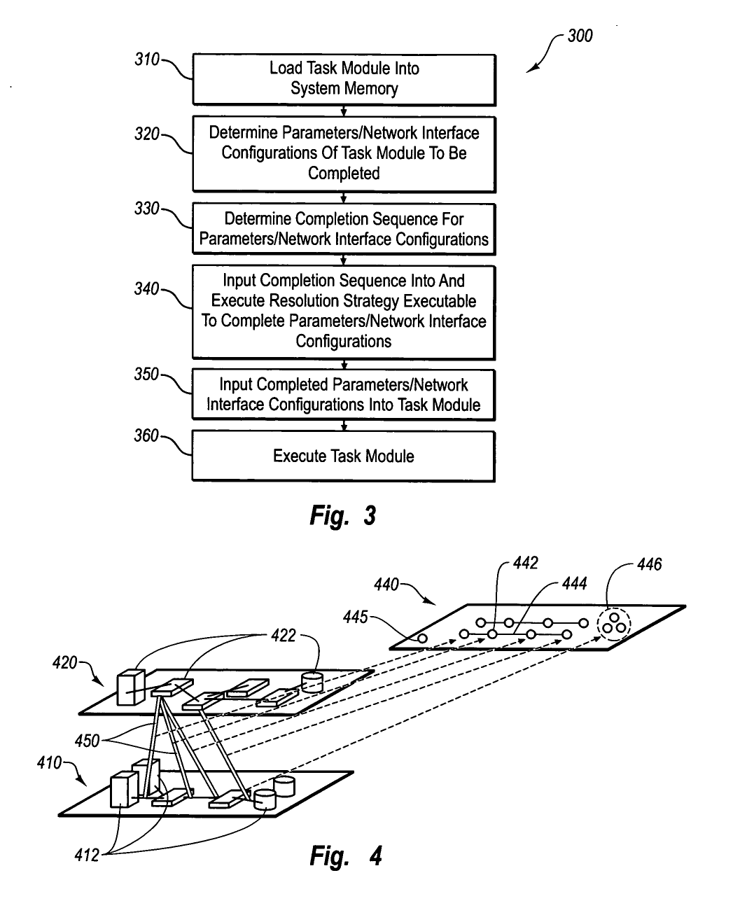

With continuing reference to FIGS. 1 and 2, reference is now made to FIG. 3, which depicts various stages of a method, generally depicted at 300, of preparing a task module having one or more parameters to be executed by an application program, such as the application program 130, in accordance with one embodiment. The method 300 includes stage 310 in which a task is loaded into system memory 140 for execution by the application program 130. The task module, such as the selected task module 200A in FIG. 1, can be loaded from a storage location, such as the storage 150. In another embodiment, however, the task module can be contemporaneously created by a user via appropriate interfacing components with computer system 110. After creation by the user, the task module can then be stored by the computer system 110 for future use. As a result, a task module is now present in the current task context of the system memory 140, as shown in FIG. 1.

In stage 320 it is determined which, if any, parameters and/or network interface configurations of the specified task are to be completed. As stated before, the task binding data structure 260 of the selected task module 200A contains executable code to introspect the specified task represented by the task module to determine which parameters/network interface configurations are present and which of those are incomplete.

In stage 330 the task binding data structure 260 is employed to determine the temporal order and hierarchy of the parameters and/or network interface configurations to be completed. In other words, the task binding data structure 260 can determine which of the parameters/network interface configurations should be completed first, second, and so on, including determining which parameters/network interface configurations should be completed before other parameters/network interface configurations, thereby establishing a hierarchy, or sequence, among the parameters/network interface configurations to be completed. This sequence is referred to herein as a completion sequence.

In stage 340 the completion sequence is employed in completing each of the parameters/network interface configurations identified in stage 320. This can be accomplished in one embodiment by a Resolution Strategy Executable (“RSE”) present in and created by the task binding data structure 260. The RSE contains executable code that is extracted from the task binding data structure 260 and is configured to receive as input the sequencing and hierarchy data from the completion sequence. The data is then utilized by the RSE to complete each parameter/network interface configuration. These actions, along with other executable elements of the task binding data structure 260, are facilitated in the illustrated embodiment by the task binding runner module 160 shown in FIG. 1, which in one embodiment is also located in the system memory 140.

Various operations can occur within the RSE in completing the needed parameters and/or network interface configurations, including creating a parallel data structure that maps the name of each parameter/network interface configuration to be completed to a particular resolution module to be executed in the RSE. Thus, executable code exists for each of the parameters to be completed in the RSE in the form of the plurality of resolution modules of the task binding data structure 260. Note that the RSE is executed together with the resolution modules in an orderly and choreographed fashion.

The resolution modules in one embodiment can utilize the scripts, wizards, and solvers 170 shown in FIG. 1 in order to complete the respective parameters/network interface configurations. In addition, other executable code rules, rule sets, etc., can also be employed in completing the parameters and network interface configuration in connection with the resolution modules and the RSE. User input via one or more graphical user interfaces can also be employed in acquiring needed information for the resolution modules and/or the RSE in order to complete a particular parameter or network interface configuration. Note that the RSE and accompanying resolution modules are executed in System Memory 140 under the control of the Task Binding Runner Module 160 until all parameters/network interface configurations, as possible, are completed.

In stage 350, once all parameters/network interface configurations for the task module 200A are completed, they are inputted into the task parameters data structure 240 of the task module.

In stage 360 the task is executed. In detail, all parameters and network interface configurations identified and completed by the task binding structure 260 in cooperation with the RSE and the various resolution modules are input into the task parameters data structure 240, as noted above. These parameters/network interface configurations are then utilized in executing the task as contained in the task program 250 of the selected task 200A.

Note that the above method implements automatic binding of the application program and selected task to the plurality of task parameters or network interface configurations. This significantly simplifies and automates binding, thereby freeing up resources for not only the computer system 110, but for a user of the computer system as well. Further, less expertise is required of the user in employing tasks that are configured in accordance with the embodiments of the present invention, which enables a greater number of users to employ the computer system.

As has been discussed, the present embodiments of the present invention are particularly relevant to tasks related to communications networks. In particular, tasks that are associated with operation of a network analyzer employed in monitoring and diagnosing problem conditions in a communications network can benefit from embodiments of the present invention.

For instance, a task may be desired to monitored specified data transmission traffic on a portion of a communications network to determine possible traffic congestion. The task can be designed such that a network analyzer notifies a user if traffic levels on a portion of the network remain elevated for a specified amount of time, i.e., levels that are consistently and statistically atypical. A user desiring to execute such a task can select, via a graphical user interface or other suitable means, a task from a task library stored in the application program, such as the plurality of task modules 200 shown in storage 150 of FIG. 1. Alternatively, the user can create the task via the graphical user interface, which can then be stored in the task library for future use.

Before the task can be executed by the application program, one or more parameters and network interface configurations of the task may need to be determined, as discussed above. The method described in connection with FIG. 3 above can be executed, thereby employing the task binding runner module 160 and the task binding data structure 260 in identifying and completing each of these parameters and network interface configurations. The various stages in FIG. 3 are executed in turn, including the formation and execution of an execution plan via the RSE together with one or more resolution modules, as described above. Once each of the parameters and network interface configurations is found and written to the task parameters data structure 240, the task program 250 can then execute, as already explained above, which results in the desired task of monitoring a portion of the communications network for elevated traffic congestion to be executed.

In the above example, instances of elevated traffic congestion may be found in the identified portion of the communications network, at which point recording of the data transmissions at the point of traffic congestion are executed by the task as directed in the selected task module 200A. Thus, one parameter or network interface configuration of the task in this instance involves the location and reservation of storage space on an available storage medium within the communications network to receive the data transmissions that are recorded by the network analyzer during the period of traffic congestion. The method of embodiments of the present invention provides for completing a parameter pertaining to this need, together with completing the network interface configuration that provides the identification and reservation of recording storage space that is instantly available should recording of data traffic need to occur. Again, this is handled automatically by the present method disclosed herein, thereby obviating the need for the user to manually set up such a system for the task. This describes but one example of completing parameter/network interface configurations that can be included in an automatic binding process of the present method.

With continuing reference to FIG. 1, reference is now made to FIG. 4, which depicts portions of a communications network to be used in accordance with one embodiment of the present invention. In particular, FIG. 4 illustrates a portion of a communications network, referred to here as a system network 410. The system network 410 includes various physical network components 412, including computers, router/switchers, and storage devices. In addition, a second portion of the communications network is shown, referred to here as a monitoring network 420. The monitoring network 420 also includes various components 422 of the communications network, such as servers, probes, network interface cards, host bus adapters, storage devices, etc. As its name implies, the monitoring network 420 is primarily employed in monitoring various connections, or nodes, of the system network 410 in connection with the monitoring and analysis functions of a network analyzer, such as the network analyzer represented by the computer system 110 in FIG. 1.

FIG. 4 also shows a monitored objects network 440, which is a virtual representation of various connections established between the system network 410 and the monitoring network 420. As such, the monitored objects network 440 operates as a virtual topography for the portion of the communications network depicted by the system network 410 and monitoring network 420, and includes link points 442 that each represent a particular connection link between a component of the monitoring network and a component or connection in the system network. In addition, the monitored objects network 440 includes various link point connections 444 that extend between link points 442 to indicate logical connections between the various links between the system network 410 and the monitoring network 420. Also shown in the monitored objects network 440 are an unlinked point 445 and a group of link points 446.

The monitored objects network 440 serves as a means by which logical connections between the system network 410 and the monitoring network 420 can be viewed and manipulated via a graphical user interface (not shown). As such, the representation of the monitored objects network 440 can be used to more easily view and manipulate the various links between the system network 410 and the monitoring network 420. Further details regarding the virtual network topology represented in FIG. 4 can be found in U.S. patent application Ser. No. 10/940,388, entitled “METHOD OF CREATING A VIRTUAL NETWORK TOPOLOGY FOR USE IN A GRAPHICAL USER INTERFACE,” filed Sep. 13, 2004, which is incorporated herein by reference in its entirety.

The virtual network environment depicted in FIG. 4 can be practiced in connection with the methods described herein, wherein in one prophetic example, a task to be executed via the application program 130 involves connecting the application program at two or more points within the communications network, which in one embodiment includes computer and storage networks. Alternatively, the task can involve connecting the application program to a particular network equipment component that in turn connects to two or more points within the communications network. In either exemplary case, logical connections must be established between the application program 130 and locations or devices depicted in the various network portions of FIG. 4. The method disclosed in connection with FIG. 3 is used here to determine the appropriate connection scheme between the application program 130 and the portions of a communications network depicted in FIG. 4.

For instance, it may be desired for a task module to link selected components 422 of the monitoring network 420 via discrete links 450 to selected connections or components 412 of the system network 410 shown in FIG. 4. The task binding data structure 260 (FIG. 2), including the RSE and the various parameter resolution modules, can utilize the virtual topography depicted by the monitored objects network 440 to determine and provide the necessary links between the monitoring network 422 and the system network 410. Each of the links 450 is represented in the monitored objects network 440 by a corresponding link point 442. Thus the task binding data structure, together with the virtual network topography represented by the monitored objects network 440, allow for a “backwards mapping” from the monitored objects network 440 to the various components 422 located in the monitoring network 420, then to the components 412 positioned in the system network 410, in preparation for task execution.

The above configuration enables, for example, the tracing of network data transmission performance along a path in the system network 410 from a start point to an end point. In this way, it is assured that the task to be executed is associated with the proper components in the monitoring network 420, and that these components are properly configured and positioned to link with corresponding components in the system network 410. In addition, should the proper links be unavailable, the present method as discussed herein can notify the user and/or application program 130 of this event and prompt corrective action to be taken.

Note that, in one embodiment, a graphical user interface is used in connection with the application program to enable a user to view and manipulate a graphical depiction of the virtual network topology together with its corresponding system and monitoring networks. The graphical user interface can further include graphical depictions of the task modules of the application program. When a user desires to execute a task module that relates to a portion of the communications network as depicted in the graphical user interface, the depiction of the task module can simply be selected and dragged to the appropriate portion of the network depiction, thereby commencing automatic binding of the task, as explained above.

With respect to computing environments, communications networks, and related components in general, at least some embodiments of the present invention may be implemented in connection with a special purpose or general purpose computer that is adapted for use in connection with communications systems. Embodiments within the scope of the present invention also include computer-readable media for carrying or having computer-executable instructions or electronic content structures stored thereon, and these terms are defined to extend to any such media or instructions for use with devices such as, but not limited to, link analyzers and multi-link protocol analyzers.

By way of example, such computer-readable media can include RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either hardwired, wireless, or a combination of hardwired or wireless) to a computer or computing device, the computer or computing device properly views the connection as a computer-readable medium. Thus, any such connection is properly termed a computer-readable medium. Combinations of the above should also be included within the scope of computer-readable media. Computer-executable instructions comprise, for example, instructions and content which cause a general purpose computer, special purpose computer, special purpose processing device, such as link analyzers and multi-link protocol analyzers, or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

A computer system as described herein can include a processing unit, a system memory, and a system bus that couples various system components including the system memory to the processing unit. The computer system is connectable to networks, such as, for example, an office-wide or enterprise-wide computer network, an intranet, and/or the Internet. The computer system can exchange data with external sources, such as, for example, remote computer systems, remote applications, and/or remote databases over such a network.

The computer system can also include a network interface through which it receives data from external sources and/or transmits data to external sources. The network interface facilitates the exchange of data with a remote computer system via a link. The link represents a portion of a network, and the remote computer system represents a node of the network.

Modules of the present invention, as well as associated data, can be stored and accessed from any of the computer-readable media associated with the computer system. For example, portions of such modules and portions of associated program data may be included in an operating system, application programs, program modules and/or program data, for storage in a system memory. When a mass storage device, such as a magnetic hard disk, is coupled to the computer system, such modules and associated program data may also be stored in the mass storage device. In a networked environment, program modules and associated data depicted relative to the computer system, or portions thereof, can be stored in remote memory storage devices, such as, for example, system memory and/or mass storage devices associated with a remote computer system. Execution of such modules may be performed in a distributed environment as previously described.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

1. A method of preparing a task module for execution by a computer system having a system memory, the method comprising:
loading the task module into the system memory;
determining at least one parameter or network interface configuration of the task module to be completed;
determining a completion sequence for the at least one task parameter or network interface configuration;
inputting the completion sequence into and executing a resolution strategy executable to complete the at least one task parameter or network interface configuration; and
inputting the at least one completed task parameter or network interface configuration into the task module and executing the task module.

2. A method of preparing a task module as defined in claim 1, wherein determining the at least one parameter or network interface configuration and determining the completion sequence is performed by a task binding data structure that is included in the task module.

3. A method of preparing a task module as defined in claim 1, wherein executing the resolution strategy executable further comprises executing the resolution strategy executable in connection with at least one resolution module to complete the at least one task parameter or network interface configuration.

4. A method of preparing a task module as defined in claim 1, wherein the computer system is in communication with a communications network.

5. A method of preparing a task module as defined in claim 1, wherein loading the task module into system memory further comprises:
loading the task module into system memory from a library of task modules stored in a storage location of the computer system.

6. A method of preparing a task module as defined in claim 1, wherein the task module that is loaded into system memory is contemporaneously created by a user.

7. A method of preparing a task module as defined in claim 1, wherein determining the completion sequence further comprises determining an order and hierarchy of multiple parameters or network interface configurations that are determined to be completed.

8. A computer system, comprising:
a system memory; and
a plurality of task modules, each task module including at least one parameter or network interface configuration that is to be completed and computer executable instructions for performing a method of completing the at least one parameter or network interface configuration, the method comprising:
by a task binding data structure included in the task module, determine a completion sequence to complete the at least one parameter or network interface configuration;
input the completion sequence into a resolution strategy executable and, execute the resolution strategy executable to complete the at least one parameter or network interface configuration; and
input the at least one completed task parameter or network interface configuration into the task module and execute the task module.

9. A computer system as defined in claim 8, wherein the computer system is a network analyzer configured to monitor data transmission via a communications network.

10. A computer system as defined in claim 9, wherein the at least one parameter or network interface configuration relates to a logical link between the computer system and a portion of the communications network.

11. A computer system as defined in claim 8, further comprising a task binding runner module that assists the task binding data structure to determine the completion sequence.

12. A computer system as defined in claim 8, wherein the method further comprises creating a parallel data structure to the resolution strategy executable.

13. A computer system as defined in claim 8, wherein the method further comprises mapping a name assigned to the at least one parameter or network interface configuration to the at least one resolution module.

14. A computer system as defined in claim 8, wherein at least one of computer executable scripts, wizards, and solvers is employed in executing the resolution strategy executable.

15. A computer system as defined in claim 8, wherein the resolution strategy executable employs at least one resolution module to complete the at least one parameter or network interface configuration.

16. A computer program product for implementing a method of preparing a task module for execution in a computer system having a system memory, the computer program product comprising:
a computer readable medium carrying computer executable instructions for performing the method, wherein the method comprises:
loading the task module into the system memory;
determining a plurality of parameters or network interface configurations of the task module to be completed;
determining a completion sequence to order the completion of each of the parameters or network interface configurations;
executing a resolution strategy executable to complete each of the parameters or network interface configurations according to the completion sequence; and
inputting the parameters or network interface configurations into the task module and executing the task module.

17. A computer program product as defined in claim 16, wherein the computer system includes a plurality of task modules stored in a storage portion thereof.

18. A computer program product as defined in claim 16, wherein a user contemporaneously creates the task module.

19. A computer program product as defined in claim 16, wherein the parameter or network interface configuration is related to a logical link between the computer system and a communications network.

20. A computer program product as defined in claim 16, wherein loading the task module further comprises:
loading the task module into the system memory via use of a graphical user interface, the graphical user interface depicting a virtual network topology relating to the communications network.

21. A computer program product as defined in claim 16, wherein the method is performed without intervention of a user.

22. A computer program product as defined in claim 16, wherein the resolution strategy executable is executed using a plurality of resolution modules.

23. A computer program product as defined in claim 16, wherein the resolution strategy executable is contained within a task binding data structure located in the task module.

24. A computer program product as defined in claim 16, wherein the completion sequence forms a temporal order in which the parameters or network interface configurations are to be completed.
